(19) United States
(12) Patent Application Publication
(10) Pub. No.: US 2024/0368028 A1
(43) Pub. Date: Nov. 7, 2024

(54) Glass Fiber Composition with Low Dielectric Loss

(71) Applicants: TAISHAN FIBERGLASS INC., Taian, Shandong (CN); CHINA NATIONAL BUILDING MATERIAL GROUP CO., LTD., Beijing (CN)

(72) Inventors: Zhiyao TANG, Taian, Shandong (CN); Yongyan LI, Taian, Shandong (CN); Jiafang WANG, Taian, Shandong (CN); Yanping ZHANG, Taian, Shandong (CN)

(21) Appl. No.: 18/289,369

(22) PCT Filed: Aug. 10, 2022
(86) PCT No.: PCT/CN2022/111308

§ 371 Date: Nov. 3, 2023

(30) Foreign Application Priority Data
Nov. 10, 2021 (CN) 202111323970.1

(51) Int. Cl. C03C 13/00; C03C 3/118; C03C 4/16

(52) U.S. Cl. CPC C03C 13/00; C03C 3/118; C03C 4/16; C03C 2204/00; C03C 2213/00

(57) ABSTRACT

The disclosure belongs to the technical field of glass fibers, and specifically relates to a glass fiber composition with low dielectric loss. The content of each component of the composition is as follows: 50-60% of SiO₂; 20-30% of B₂O₃; 8-18% of Al₂O₃; 1-6% of CaO; 0.2-1.50% of F₂; 0.05-0.5% of SnO₂; 0.05-0.5% of Li₂O; and K₂O+Na₂O≤0.05%. In the disclosure, SnO₂ and F₂ are both added, and the ratio of F₂/SnO₂ is controlled, such that not only glass fibers have relatively low dielectric constant and dielectric loss, but also the viscosity of the glass fibers is reduced, so that the number of bubbles in the glass fibers is zero. According to the disclosure, various components interact with one another, such that the glass fiber composition obtained has the low dielectric constant, low dielectric loss, few bubbles, low viscosity, and excellent glass performance.

### TECHNICAL FIELD

The disclosure belongs to the technical field of glass fibers, and specifically relates to a glass fiber composition with low dielectric loss.

### BACKGROUND

With the development of 5th Generation Mobile Communication Technology (5G), performance requirements for low dielectric materials are more stringent. The greatest advantage of 5G is a fast propagation speed, and the greatest disadvantage brought thereby is the poor penetrating power and large attenuation. Glass converts partial electrical energy into heat energy in high-frequency electromagnetic fields, thus loss is produced. This requires materials of propagation media to have the characteristics of low dielectric constant and low dielectric loss. In this way, it may be achieved that the signal transmission is faster, the signal delay is lower, and the signal fidelity is higher.

Chinese patent application CN102503153A disclosed a low dielectric constant glass fiber, including: 48 wt %˜58 wt % of SiO₂; 10 wt %˜18 wt % of Al₂O₃; 18 wt %˜28 wt % of B₂O₃; 0˜6 wt % of CaO; 0˜6 wt % of MgO; 0.5 wt %˜8 wt % of Y₂O₃; 0.2 wt %˜0.6 wt % of CeO₂; 0˜3 wt % of F₂; 0˜1 wt % of Na₂O, K₂O, and Li₂O; 0˜0.45 wt % of TiO₂; and 0˜0.5 wt % Fe₂O₃. The glass fiber has a dielectric constant of 4.1˜4.5 and a dielectric loss of 6×10⁻⁴˜9×10⁻⁴ at a room temperature and a frequency of 1 MHZ.

Chinese patent application CN104556710A disclosed a special-shaped glass fiber and a preparation method thereof. The special-shaped glass fiber includes the following components in molar percentage: 52%˜58% of SiO₂; 16%˜24% of B₂O₃; 13%˜19% of Al₂O₃; 1%˜5% of CaO; 4.2%˜8% of MgO; 0.4%˜2% of F₂; 0˜0.5% of Li₂O; 0˜0.4% of Fe₂O₃; 0˜0.2% of K₂O; and 0˜0.2% of Na₂O. The dielectric constant of the special-shaped glass fiber at the room temperature and the frequency of 1 MHz is less than 4.7, and the dielectric loss factor is less than 10⁻³.

Chinese patent application CN103482876A disclosed a low dielectric constant glass fiber used for a printed circuit board, including the following components in mass percentage: 48%˜53% of SiO₂; 13%˜16% of Al₂O₃; 19%˜25% of B₂O₃; 0.5%˜2% of P₂O₅; 5.0%˜8.5% of CaO; 0.5%˜8% of La₂O₃; 0.5%˜2.5% of ZnO; 0.5%˜2% of TiO₂; Na₂O, K₂O, and Li₂O are less than 1%; SO₃ is less than 0.45%; and Fe₂O₃ is less than 0.45%. It has the very low dielectric constant and dielectric loss. At the room temperature and the frequency of 1 MHZ, the dielectric constant is 4.8˜5.5, and the dielectric loss is 4˜8×10⁻⁴.

Although the glass fiber in the above patent has the relatively low viscosity, its dielectric properties are detected under 1 MHz conditions and the dielectric loss of the glass is increased with the increased frequency. For example, at the room temperature and 1 MHz, silicate glass tan δ=9×10⁻⁴, and at 3000 MHz, it is 36×10⁻⁴. So the above patent only has the relatively low dielectric loss when detected at the room temperature and 1 MHZ.

Chinese patent application CN113135666A disclosed a low dielectric glass fiber, including 50˜58% of SiO₂; 10˜16% of Al₂O₃; 20˜28% of B₂O₃; 1˜4% of MgO; 1˜4% of CaO; 0.05˜0.5% of Li₂O; 0.05˜0.6% of Na₂O; 0.05˜0.8% of K₂O; 0.2˜1.5% of TiO₂; 0˜1% of CeO₂; 0.01˜1.5% of SnO₂; and 0˜0.1% of Fe₂O₃. By reasonably setting the ratio of silicon oxide, aluminum oxide, and boron oxide, the glass fiber has the relatively low dielectric constant and dielectric loss, and the glass viscosity is adjusted appropriately. The dielectric constant of the glass fiber at the room temperature and a frequency of 10 GHz is 4.2-4.5, and the dielectric loss is 2.5×10⁻³-4.4×10⁻³. The dielectric constant and dielectric loss in this patent are relatively high.

Based on the above problems, there is an urgent need to develop a glass fiber composition with low dielectric constant, low dielectric loss, low viscosity, and zero bubbles suitable for large-scale production at a high frequency.

### SUMMARY

A purpose of the disclosure is to provide a glass fiber composition with low dielectric constant, low dielectric loss, low viscosity, and zero bubbles.

The glass fiber composition with low dielectric loss described in the disclosure has the following component contents in mass percentage:

SiO₂: 50-60%;

B₂O₃: 20-30%;

Al₂O₃: 8-18%;

CaO: 1-6%;

F₂: 0.2-1.50%;

SnO₂: 0.05-0.5%;

Li₂O: 0.05-0.5%;

K₂O+Na₂O≤0.05%.

Preferably, the glass fiber composition with low dielectric loss has the following component contents in mass percentage:

SiO₂: 50-60%;

B₂O₃: 20-30%;

Al₂O₃: 8-18%;

CaO: 1-6%;

F₂: 0.2-1.50%;

P₂O₅: 0.05-5%;

SnO₂: 0.05-0.5%;

Li₂O: 0.05-0.5%;

K₂O+Na₂O≤0.05%.

Preferably, the glass fiber composition with low dielectric loss has the following component contents in mass percentage:
SiO₂: 50-60%;
B₂O₃: 20-30%;
Al₂O₃: 8-18%;
CaO: 1-6%;
F₂: 0.2-1.50%;
SnO₂: 0.05-0.5%;
Li₂O: 0.05-0.5%;
K₂O+Na₂O≤0.05%;
0<MgO<2.0.

Preferably, the glass fiber composition with low dielectric loss has the following component contents in mass percentage:

SiO₂: 50-60%;

B₂O₃: 20-30%;

Al₂O₃: 8-18%;

CaO: 1-6%;

F₂: 0.2-1.50%;

P₂O₅: 0.05-5%;

SnO₂: 0.05-0.5%;

Li₂O: 0.05-0.5%;

K₂O+Na₂O≤0.05%;

0<MgO<2.0.

Herein:

The mass percentage content of SnO₂ and Li₂O satisfies a range of 0.2-3 for SnO₂/Li₂O.

The mass percentage content of F₂ and SnO₂ satisfies a range of 1-5 for F₂/SnO₂.

The mass percentage content of P₂O₅, F₂, and SnO₂ satisfies a range of 2-5 for P₂O₅/(F₂+SnO₂).

Raw materials for preparing the glass fiber composition of the disclosure are quartz powder, boron anhydride, aluminum oxide, wollastonite, magnesium oxide, tin oxide, fluorite, aluminum metaphosphate, and spodumene.

The beneficial effects of the disclosure are as follows.

SiO₂ forms an irregular continuous network structure by a structure of silica tetrahedron, this structure has the relatively high bond strength, and the structure is compact. It is not easily polarized under the action of an external electric field, and it does not easily produce losses such as conduction and relaxation. Therefore, the high content of SiO₂ may significantly reduce the dielectric constant and dielectric loss of glass, and enhance the mechanical strength. However, the increased content may increase the viscosity and increase the difficulty of melting. For example, quartz glass has a very low dielectric loss of 0.0001, but its viscosity is high, and it is difficult to melt. The disclosure limits the SiO₂ content range to 50%-60%.

In B₂O₃, boron exists as a boron-oxygen triangle at the high temperature, the viscosity may be reduced. However, when the boron content reaches a certain value, it may actually increase the viscosity. Therefore, the boron content should not be too high, and it is not beneficial to production. Moreover, the B₂O₃ content is too high, a SiO₂ grid is easily precipitated, and the phase separation is generated. In addition, the addition of B₂O₃ introduces B³⁺ to form B—O, and the bond energy of this bond is larger than that of Si—O. It may play a role of stabilizing the glass network structure and limiting the polarization of oxygen ions in the glass. Therefore, the addition of B₂O₃ may reduce the dielectric constant and dielectric loss. The disclosure limits the B₂O₃ content range to 20%-30%.

The addition of Al₂O₃ may effectively inhibit the crystallization of the glass. In multi-component glass, Al₂O₃ may play a role in connecting the fracture network, so that the network structure is compact, and the glass strength is improved. However, the Al—O bond energy is weaker than the Si—O bond energy, so that free oxygen is increased, and thus the loss is increased. The disclosure limits the Al₂O₃ content range to 8%-18%.

CaO belongs to an outer body of the network, the coordination number of calcium ions is 6 generally, and it has little activity in the structure and is generally not easy to precipitate from the glass. It has the greater activity at the high temperature. Ca²⁺ has the function of polarizing bridge oxygen and weakening silicon-oxygen bonds, this makes it have the function of reducing the viscosity and shortening material properties. At the same time, the loss caused by the free oxygen may be increased. The disclosure limits the CaO content range to 1%-6%.

The disclosure may also add MgO on the basis of adding SnO₂ and F₂. MgO may reduce the viscosity of the glass in the glass system, but the content is too high, the dielectric constant and dielectric loss may be increased. The disclosure limits the MgO content range to MgO<2.0.

P₂O₅ always exists in the glass structure in the form of phosphorus-oxygen tetrahedron, and is a glass forming body. It may serve as a skeleton of the glass, to improve the phase separation temperature of the glass, enhance the temperature resistance of the glass, and also shorten the material properties of the glass. In technical researches, a differential scanning calorimetry (DSC) is used to detect the expansion and softening point temperature of the glass, and it is found that after P is introduced, the softening point temperature of the glass is raised compared to before the introduction of P, and it is beneficial to improve the temperature resistance of subsequent products. In addition, the single P₂O₅ raw material is prone to moisture absorption and agglomeration in the blending process, so that the uniformity of blended materials is poor, and the requirements for storage conditions are high. The disclosure introduces P₂O₅ by an aluminum metaphosphate or condensed aluminum phosphate raw material, so that P₂O₅ is dispersed uniformly in the blended material. The melting speed of B₂O₃ is fast in the melting process of the blended material, and it is partially wrapped by P₂O₅ distributed uniformly, thus the volatile quantity is reduced, and the gas emission is reduced. However, the excessive introduction leads to a significant increase in low-temperature viscosity, and the high content of P may easily compete with B for the free oxygen, the glass devitrification is caused, and the crystallization is generated. It is found from the disclosure that when the Al₂O₃ content is >8, it may effectively inhibit the phase separation caused by the introduction of high B and P. By controlling the ratio of Al₂O₃, P₂O₅, and B₂O₃, the forming temperature of the glass is reduced, and the crystallization is inhibited. The disclosure controls the P₂O₅ content range to 0.05%-5%.

As alkali metal oxides such as Li₂O, K₂O, and Na₂O, the viscosity characteristics of the glass may be decreased rapidly, and it is beneficial for glass melting and clarification. However, bonds formed by the alkali metals and oxygen are easily polarized, so that the dielectric loss is significantly increased. The disclosure adds a small amount of Li₂O to reduce the viscosity under the premise of guaranteeing the dielectric loss, and it is beneficial for the glass melting. The disclosure strictly controls the content of K₂O and Na₂O in the raw material, and a small amount of which is introduced as impurities in the raw material without adding. The disclosure limits the range of Li₂O to 0.05-0.5%, and K₂O+Na₂O≤0.05%, so it is guaranteed that glass with low dielectric loss is obtained at a relatively low melting temperature.

SnO₂ is decomposed at the high temperature to generate O₂, the gas partial pressure is reduced, and it is beneficial to the discharge of bubbles. More importantly, SnO₂+Li₂O of the disclosure acts as a composite clarifier, which is interfered by an Sn⁴⁺ external electronic layer, so that the polarization effect of Lit is enhanced, and the beneficial effects of Li₂O are effectively improved. In the glass clarification process, the surface tension of glass liquid is reduced, the bubbles are efficiently discharged, and the uniformity of the glass is improved, as to achieve the zero bubble rate required for the low dielectric glass fiber production. In addition, the melting temperature of the blended material is greatly reduced, thereby the volatilization of B and F is reduced. The disclosure controls the SnO₂ content range to 0.05-0.5%, and the range of the weight percentage ratio of SnO/Li₂O is 0.2-3.

F atoms have a small radius and are not easily polarized compared to O atoms. It forms a Si—F bond with Si, partially replacing Si—O, and plays a network breaking role in the glass network. In addition, the bond strengths of Si—F, B—F, and Al—F formed in the glass is stronger than those of Si—O, B—O, and Al—O bonds. This dual effect may reduce the melting temperature, viscosity, and surface tension of the glass, and it is beneficial for reducing the difficulty of a glass forming process. In addition, the formed Si—F bond is not easily polarized, and the dielectric loss is reduced. The disclosure controls the F₂ content range to 0.2%-1.5%.

In addition, the content ratio of F₂ to SnO₂ in the disclosure has a significant impact on the dielectric loss of the glass. When a small amount of SnO₂ is introduced, the two are cooperated with each other, so that the reduction in dielectric loss is more apparent. When the range of the weight percentage ratio of F₂/SnO₂ in the disclosure is 1-5, the effect is apparent. It is indicated from experiments that the purpose of the disclosure may not be achieved when F₂ or SnO₂ is added alone or the range of F₂/SnO₂ is not 1-5. When F₂ and SnO₂ are used together, F₂ is dispersed around SnO₂, to forming the Sn—F bond that works together with Si—F, B—F, and Al—F to further reduce the melting temperature, viscosity, and surface tension of the glass.

In conclusion, the disclosure simultaneously adds SnO₂ and F₂, and controls the ratio of F₂/SnO₂, which not only makes the glass fiber have the relatively low dielectric constant and dielectric loss, but also reduces the viscosity of the glass fiber, so that the number of the bubbles in the glass fiber is zero.

In addition, the disclosure may also add P₂O₅ on the basis of adding SnO₂ and F₂, and control the ratio range of P₂O₅/(F₂+SnO₂) to 2-5, thus the dielectric constant and dielectric loss of the glass fibers are further reduced.

The various components of the disclosure are interacted, so that the glass fiber composition obtained has the low dielectric constant and low dielectric loss, few bubbles, low viscosity, and excellent glass performance.

### DETAILED DESCRIPTION OF THE EMBODIMENTS

The disclosure is further described below in combination with embodiments.

### Embodiments 1-7

Components of the glass fiber composition with low dielectric loss in Embodiments 1-7 are shown in Table 1.
(1) According to the content of each component, each compound is mixed in a certain ratio, and after being mixed uniformly, a blended material is placed in a platinum crucible, then it is melted at 1550-1600° C., and it is wire-drawn at less than 1350° C. to prepare a glass fiber.

In order to guarantee that glass has the sufficient strength and adapts to a wire-drawing process, modulus strength detection is performed: the glass is cut into glass blocks of 20*20*15 mm (length*width*thickness), the testing surface is smooth and flat. An ultrasonic thickness gauge is used, the unit of the actual sound velocity measured by the thickness gauge is mm/us, so the sound velocity value (cm/s) in the following formula is: measured value*10⁵, density unit: g/cm³, and required data may be calculated by substituting it.

$$Poisson ratio ( v ) = \frac{1 - 2 {( {V}_{T} / {V}_{L} )}^{2}}{2 - 2 {( {V}_{T} / {V}_{L} )}^{2}} \qquad ( 1 )$$

Herein, V_{T}-transverse wave velocity (cm/s), V_{L}=longitudinal wave velocity (cm/s).

$$Young modulus ( E ) = \frac{{V}_{L}^{2} ρ ( 1 + v ) ( 1 - 2 v )}{1 - v} \qquad ( 2 )$$

Herein, V_{L}=longitudinal wave velocity (cm/s), ρ=density (g/cm³), v=poisson ratio.
(3) Dielectric performance detection: the blended material mixed uniformly is placed and melted in the platinum crucible, a sample melted is annealed at 600° C. to eliminate stress, and then it is cut into the sample of @50*2 mm, and tested at 10 GHz by using a network vector analyzer.

Data of various indicators such as Ig3.0 temperature, liquid phase temperature, ΔT, dielectric constant, dielectric loss, modulus, and bubble number of the glass fiber composition are shown in Table 1.

### Contrast Examples 1-6

Components of the glass fiber composition in Contrast examples 1-6 are shown in Table 2.

Data of various indicators such as Ig3.0 temperature, liquid phase temperature, ΔT, dielectric constant, dielectric loss, modulus, and bubble number of the glass fiber composition are shown in Table 2.

TABLE 1
Data table for Embodiments 1-7

| | Content | Embodi- | Embodi- | Embodi- | Embodi- | Embodi- | Embodi- | Embodi- |
|---|---|---|---|---|---|---|---|---|
| | range | ment 1 | ment 2 | ment 3 | ment 4 | ment 5 | ment 6 | ment 7 |
| SiO₂ | 50-60 | 55 | 60 | 50 | 56.43 | 57 | 56.44 | 53 |
| B₂O₃ | 20-30 | 22.5 | 20.8 | 27.77 | 24 | 21.5 | 25.5 | 24 |
| Al₂O₃ | 8.0-18 | 13.87 | 13.83 | 12 | 13 | 11.85 | 13 | 16 |
| CaO | 1.0-6.0 | 3.5 | 2.1 | 5 | 4.1 | 5 | 4.1 | 4 |
| MgO | <2.0 | 0 | 0 | 0 | 0 | 1 | 0 | 1.22 |
| P₂O₅ | 0.05-5.0 | 4 | 2 | 4.1 | 1.5 | 2.5 | 0 | 0 |
| F₂ | 0.2-1.5 | 0.8 | 0.6 | 0.6 | 0.4 | 0.8 | 0.4 | 1.2 |
| SnO₂ | 0.05-0.5 | 0.2 | 0.35 | 0.3 | 0.15 | 0.2 | 0.15 | 0.25 |
| Li₂O | 0.05-0.5 | 0.1 | 0.3 | 0.2 | 0.4 | 0.15 | 0.4 | 0.3 |
| K₂O + Na₂O | ≤0.05 | 0.03 | 0.02 | 0.03 | 0.02 | 0 | 0.01 | 0.03 |
| F₂/SnO₂ | 1.0-5.0 | 4.00 | 1.71 | 2.00 | 2.67 | 4.00 | 2.67 | 4.80 |
| P₂O₅(F₂ + SnO₂) | 2-5 | 4.00 | 2.11 | 4.56 | 2.73 | 2.50 | 0.00 | 0.00 |
| SnO₂/Li₂O | 0.2-3 | 2.00 | 1.17 | 1.50 | 0.38 | 1.33 | 0.38 | 0.83 |
| Ig3.0/° C. | | 1310 | 1335 | 1320 | 1316 | 1308 | 1305 | 1300 |
| Liquid phase | | 1050 | 1123 | 1060 | 1080 | 1023 | 998 | 1010 |
| temperature/° C. | | | | | | | | |
| ΔT/° C. | | 260 | 212 | 260 | 236 | 285 | 307 | 290 |
| Dielectric | | 4.1 | 4.07 | 4.15 | 4.12 | 4.15 | 4.18 | 4.16 |
| constant 10 GHz | | | | | | | | |
| Dielectric loss 10 | | 0.0015 | 0.0013 | 0.0013 | 0.0016 | 0.0016 | 0.0018 | 0.0017 |
| GHz | | | | | | | | |
| Modulus /GPa | | 60 | 65 | 60 | 60 | 62 | 59 | 63 |
| Bubble number | | 0 | 0 | 0 | 0 | 0 | 0 | 0 |
| (bubbles/10 g) | | | | | | | | |

TABLE 2
Data table for Contrast examples 1-6

| | Contrast | Contrast | Contrast | Contrast | Contrast | Contrast |
|---|---|---|---|---|---|---|
| | example 1 | example 2 | example 3 | example 4 | example 5 | example 6 |
| SiO₂ | 55 | 55 | 60 | 60 | 55 | 55 |
| B₂O₃ | 22.2 | 22.5 | 20.8 | 20.8 | 22.5 | 22.5 |
| Al₂O₃ | 13.87 | 14.07 | 14.08 | 14.33 | 14.67 | 14.87 |
| CaO | 3.5 | 3.5 | 2.1 | 2.1 | 3.5 | 3.5 |
| MgO | 0 | 0 | 0 | 0 | 0 | 0 |
| P₂O₅ | 4 | 4 | 2 | 1.5 | 4 | 4 |
| F₂ | 0.8 | 0.8 | 0.6 | 0.6 | 0 | 0 |
| SnO₂ | 0.5 | 0 | 0.1 | 0.35 | 0.2 | 0 |
| Li₂O | 0.1 | 0.1 | 0.3 | 0.3 | 0.1 | 0.1 |
| K₂O + Na₂O | 0.03 | 0.03 | 0.02 | 0.02 | 0.03 | 0.03 |
| F₂/SnO₂ | 1.60 | 0.00 | 6.00 | 1.71 | 0 | 0 |
| P₂O₅/(F₂ + SnO₂) | 3.08 | 5.00 | 2.86 | 1.58 | 20 | 0 |
| SnO₂/Li₂O | 5.00 | 0.00 | 0.33 | 1.17 | 2 | 0 |
| Ig3.0/° C. | 1360 | 1375 | 1365 | 1392 | 1384 | 1398 |
| Liquid phase | 1079 | 1100 | 1110 | 1200 | 1153 | 1164 |
| temperature/° C. | | | | | | |
| ΔT/° C. | 281 | 275 | 255 | 192 | 231 | 234 |
| Dielectric constant | 4.55 | 4.52 | 4.55 | 4.58 | 4.59 | 4.65 |
| 10 GHz | | | | | | |
| Dielectric loss 10 | 0.0035 | 0.0033 | 0.0028 | 0.0030 | 0.0029 | 0.0031 |
| GHz | | | | | | |
| Modulus /GPa | 54 | 55 | 58 | 60 | 52 | 51 |
| Bubble number | 10 | 22 | 25 | 12 | 20 | 30 |
| (bubbles/10 g) | | | | | | |

In the table, Ig3.0 refers to the temperature at which the viscosity of glass liquid is 1000 poises, which is the forming temperature of the glass, namely the wire-drawing temperature; the liquid phase temperature refers to an upper limit of the crystallization temperature or phase separation temperature, which is the upper limit of the glass devitrification temperature; and the difference between the forming temperature and the liquid phase temperature is larger, it is more beneficial for wire-drawing.

The data in Tables 1-2 are analyzed, the ratio of SnO₂/Li₂O in Contrast example 1 is 5.00, which is not within the range of 0.2-3; the ratio of F₂/SnO₂ in Contrast example 3 is 6.00, which is not within the range of 1-5; and the ratio of P₂O₅/(F₂+SnO₂) in Contrast example 4 is 1.58, which is not within the range of 2-5. This leads to an increase in viscosity of the glass fiber, and the number of the bubbles in the glass fiber is also increased to varying degrees.

By comparing Embodiment 1 with Contrast examples 2, 5, and 6, it may be seen that compared to Embodiment 1 of the disclosure, SnO₂ is not added in Contrast example 2, F₂ is not added in Contrast example 5, and SnO₂ and F₂ are not added in Contrast example 6, which all lead to the increase in viscosity of the glass fiber, so that the number of the bubbles in the glass fiber is increased. The disclosure simultaneously adds SnO₂ and F₂, and controls the ratio of F₂/SnO₂, which not only makes the glass fiber have the relatively low dielectric constant and dielectric loss, but also reduces the viscosity of the glass fiber, so that the number of the bubbles in the glass fiber is zero. In addition, the disclosure may also add P₂O₅, and control the ratio range of P₂O₅/(F₂+SnO₂) to 2-5, thus the dielectric constant and dielectric loss of the glass fibers are further reduced.

1. A glass fiber composition with low dielectric loss, wherein calculated by mass percentage, the content of each component is as follows:
SiO₂: 50-60%;
B₂O₃: 20-30%;
Al₂O₃: 8-18%;
CaO: 1-6%;
F₂: 0.2-1.50%;
SnO₂: 0.05-0.5%;
Li₂O: 0.05-0.5%;
K₂O+Na₂O≤0.05%;
the mass percentage content of SnO₂ and Li₂O satisfies a range of 0.2-3 for SnO₂/Li₂O; and
the mass percentage content of F₂ and SnO₂ satisfies a range of 1-5 for F₂/SnO₂.

2. The glass fiber composition with low dielectric loss according to claim 1, wherein the glass fiber composition further comprises P₂O₅; and calculated by mass percentage, the content of each component is as follows:
SiO₂: 50-60%;
B₂O₃: 20-30%;
Al₂O₃: 8-18%;
CaO: 1-6%;
F₂: 0.2-1.50%;
P₂O₅: 0.05-5%;
SnO₂: 0.05-0.5%;
Li₂O: 0.05-0.5%;
K₂O+Na₂O≤0.05%;
the mass percentage content of SnO₂ and Li₂O satisfies a range of 0.2-3 for SnO₂/Li₂O;
the mass percentage content of F₂ and SnO₂ satisfies a range of 1-5 for F₂/SnO₂; and
the mass percentage content of P₂O₅, F₂, and SnO₂ satisfies a range of 2-5 for P₂O₅/(F₂+SnO₂).

3. The glass fiber composition with low dielectric loss according to claim 1, wherein the glass fiber composition further comprises MgO; and calculated by mass percentage, the content of each component is as follows:
SiO₂: 50-60%;
B₂O₃: 20-30%;
Al₂O₃: 8-18%;
CaO: 1-6%;
F₂: 0.2-1.50%;
SnO₂: 0.05-0.5%;
Li₂O: 0.05-0.5%;
K₂O+Na₂O≤0.05%;
0<MgO<2.0;
the mass percentage content of SnO₂ and Li₂O satisfies a range of 0.2-3 for SnO₂/Li₂O; and
the mass percentage content of F₂ and SnO₂ satisfies a range of 1-5 for F₂/SnO₂.

4. The glass fiber composition with low dielectric loss according to claim 1, wherein the glass fiber composition further comprises P₂O₅ and MgO; and calculated by mass percentage, the content of each component is as follows:
SiO₂: 50-60%;
B₂O₃: 20-30%;
Al₂O₃: 8-18%;
CaO: 1-6%;
F₂: 0.2-1.50%;
P: 05:0.05-5%;
SnO₂: 0.05-0.5%;
Li₂O: 0.05-0.5%;
K₂O+Na: 0≤0.05%;
0<MgO<2.0);
the mass percentage content of SnO₂ and Li₂O satisfies a range of 0.2-3 for SnO₂/Li₂O;
the mass percentage content of F₂ and SnO₂ satisfies a range of 1-5 for F/SnO₂; and
the mass percentage content of P₂O₅, F₂, and SnO₂ satisfies a range of 2-5 for P₂O₅/(F₂+SnO₂).
